(19) United States
(12) Patent Application Publication
(10) Pub. No.: US 2015/0213571 A1
(43) Pub. Date: Jul. 30, 2015

(54) Methods and Systems for a Treatment Center Marketplace

(71) Applicant: Coorperative Health Solutions, LLC, Lexington, MA (US)

(72) Inventors: Katherine Chambers, Houston, TX (US); Alan Abrams, Lexington, MA (US)

(21) Appl. No.: 14/610,622

(22) Filed: Jan. 30, 2015

Related U.S. Application Data
(60) Provisional application No. 61/933,464, filed on Jan. 30, 2014.

(51) Int. Cl. G06Q 50/22; G06Q 10/00; H04L 29/06

(52) U.S. Cl. CPC G06Q 50/22; H04L 67/42; G06Q 10/00

(57) ABSTRACT

A computerized-method of matching a patient with a treatment center is provided. The method involves establishing electronic communication between a hospital and a treatment center, transmitting patient information, and making a determination of availability based, in part, on the patient information.

### CROSS REFERENCE TO RELATED APPLICATIONS

This application claims the benefit of and priority to U.S. Provisional Patent Application No. 61/933,464, filed Jan. 30, 2014, which is owned by the assignee of the instant application and the entire disclosure of which is incorporated herein by reference.

### FIELD OF THE INVENTION

The invention relates generally to computer-based methods and systems for matching a patient with a treatment center. More specifically, the invention relates to computer-based methods and systems for matching a patient with a treatment center based on patient information, treatment center information and/or healthcare rule requirements

### BACKGROUND

Currently healthcare costs can be exorbitant and many of the processes surrounding patient management are inherently inefficient and cumbersome based on legacy computing systems and manual processes. Opportunities to streamline processes, cut costs and/or create better quality of care for patients are driving an unprecedented level of development of new and improved healthcare information technology (HIT) systems.

Many treatment centers (e.g., nursing facilities) have been around since the early 20th century, providing care for the elderly in much the same way as decades ago. However, the last 15 to 20 years mark a significant transformation in the patient demograph at skilled nursing facilities (SNF) as Medicare offers patient benefits for those requiring medical care that can be managed outside a hospital setting. Managing care outside of a hospital setting has contributed to creating a new market for SNF services to aid in short-term care and rehabilitation. This influx of short-term patients has created the need for a more dynamic bed inventory management process for SNFs, yet the industry still largely relies on traditional placement processes. The traditional placement processes were originally used to place long-term patients with less urgency and less turnover of bed inventory, thus traditional placement processes can cause difficulty when managing shorter-term patients.

In current patient/treatment center matching processes, patients are referred to a treatment center by a referring institution. Exemplary, referring institution include hospitals, physician offices, urgent care clinics, home health agencies, Long Term Accute Care Hospitals, or any institution that refers patients to treatment center.

In the case of a referring institution of a hospital, hospital patient's typically qualify for treatment center admission for rehabilitation following a required minimum duration stay (e.g., three days) at the hospital. Many patients (e.g., over 40 percent) requiring post-acute hospital services are discharged to a SNF. Once a physician determines a patient will require a post-acute stay at a treatment center, the placement process begins.

A referring institution employee (e.g., hospital employee, case manager, social worker, receptionist, or nurse) typically leads the process by emailing, calling and/or faxing information back and forth with directors of admissions at treatment centers that are known by the referring institution employee. Referring institution employees and treatment center admissions staff typically develop relationships over time to help wade through the referrals and to advance qualified leads just as with any traditional sales process.

Many treatment centers send employees to referring institutions to build relationships to ensure referrals. For example, many SNFs place full time employees as screeners/hospital liaisons/clinical admissions directors at hospitals (e.g., hospitals know to be patient feeders to the particular SNF) to ensure they can identify and secure prospective patients quicker than their competitors. These screeners and SNF admissions personnel spend time developing relationships with hospital employees. These are cultivated relationships to benefit both sides as the hospital employee wants to discharge the patient as quickly as possible while the SNF admissions contact wants to source and secure the most “appropriate” patient for the SNF's needs.

This back and forth matching process is dependent on several people relying on disparate methods of communication, electronic data and paperwork. It is an unstructured process that is grossly inefficient. For example, the process limits treatment center options to the treatment centers the referring institution's employee is aware of firsthand or via a co-worker or word of mouth. The limited universe of treatment centers presented to the patient can cause difficulties and poorer outcomes if a patient is placed in a facility that may not be best suited to meet a patient's specific needs.

One difficulty is that frequently none of the treatment centers that the referring institution's employee knows of has available beds for specific patient's needs (e.g., gender). This can lead to a patient waiting unnecessarily for a bed. For example, a patient may wait in the hospital for days until a bed opens up. For geriatric patients, this process can cause permanent functional disabilities and/or poorer quality of life, as studies have shown that every extra day a geriatric patient stays in the hospital they lose, on average 1-3 percent of their muscle. This can be particularly damaging for elderly patients, as it can take up to two days of exercise to reverse one day of muscle loss in older populations.

Another difficulty is that the particular treatment centers presented to the patient may not be the best medical fit for the patient. For example, a particular SNF may be capable of handling the patient's particular medical need, but another SNF, not presented to the patient, may be experts in handling the patient's particular medical need. The manual human process of referring patients to after care (e.g., calling treatment centers for beds) can cause the patient to miss the opportunity to go to the treatment center that can best meet their needs. Instead, in many cases the patient gets inferior care based solely on the limitations of the manual human referral process.

Placing patients in less than optimal treatment centers can also contribute to a higher rate of hospital re-admittance. For example, currently nearly 24% of Medicare patients discharged from a hospital to a SNF are readmitted to a hospital within 30 days. Medicare hospital readmissions cost $26 billion annually with more than $17 billion of which is estimated to be avoidable. This revolving door of hospital readmissions has led to the implementation of the October 2012 Readmission Penalty Program under the Patient Protection and Affordable Care Act and is an incentive for hospitals to consider new methods and tools for patient discharge placement. While the cause for hospital readmissions can be multifaceted, one of the most critical components in avoiding readmissions is to ensure patients are placed in the most appropriate treatment center to meet their needs rather than relying on the current subjective, manual process.

Another difficulty with the manual placement process is that all of the patient information is orally communicated and manually recorded between the referring institution's employee and the treatment center admissions administrator, thus causing a high rate of errors in the transfer of the patient's information.

In addition to the difficulties with the manual human process for matching, there are several key factors that suggest there is an industry need for a technological solution to streamline and better structure the patient matching process into treatment centers. For example, in the case of a SNF treatment center, currently there are approximately 5,000 hospitals in the United States and approximately 15,000 SNFs. Each year, there are over 2.5 million admissions to SNFs from hospitals representing over $30 billion dollars in Medicare payments to SNFs alone. Medicare covers 100% of the first 20 days of a SNF stay for beneficiaries and this is notable as the majority (˜78%) of patients stay fewer than 40 days. Leaving the patients with high after-care bills. Further, while Medicare-covered SNF patients are typically a small share of a facility's total patient population (12%) they represent a larger share of the facility's payments (23%).

The SNF market has consistently run at a high occupancy (for example, between 86-88% nationally since 2001). This rate is of particular importance when considering that there will be over 72 million elderly Americans aging into Medicare by 2030—more than double the number from 2000. This explosion in the aging population can create an increase in demand for services from SNFs, further exacerbating inefficiencies in current admissions practice and potentially causing a lack of bed inventory for after-care treatment.

Furthermore, the SNF market is highly fragmented with 50 of the largest operating companies accounting for only 20% of all SNF revenue in the US. A highly fragmented market aiming to serve a different patient mix of short-term patients, experiencing high volume and high chum of bed inventory makes relying on fielding faxes, disparate emails and phone calls between hospital employees and treatment centers to identify patients to fill empty beds on a daily basis from a multitude of sources results in ineffective placement, longer stays, higher reoccurrence of hospital reentry and poor transmission of patient information.

Therefore, it is desirable to provide a method for matching a patient with a treatment center that: optimizes the likelihood that the patient is placed in the best facility to meet the patient's needs; provides an optimal number of treatment center placement options to the patients: eliminates subjective bias for placement that comes about from the limited number of treatment centers in the awareness of the hospital employees; decreases the likelihood of hospital reentry; increases the likelihood of a match; decreases costs; and helps to ensure accuracy of patient information transferred between the hospital employees and the treatment center admissions administrators.

### SUMMARY OF THE INVENTION

One advantage of the claimed invention includes optimizing the likelihood that the patient is placed in the best facility to meet the patient's needs due to an increase in the number of treatment center options presented to a referring institution's employee and elimination of the subjective bias of the referring institution's employee using a computing system for placement provides. The computing system provides an almost immediate responsellist of possible treatment centers for each specific patient's needs. The qualitative (e.g., expertise or capability of a treatment center to serve a particular illness) and quantitative criteria (e.g., occupancy of a treatment center, how many male beds or female beds available) used in making a match also contribute to optimizing the likelihood that the patient is placed in the best facility.

Another advantage is that the claimed invention provides an optimal number of treatment center placement options to the patients due to an increase of the number of treatment centers considered for a match.

Another advantage of the claimed invention is that it eliminates subjective bias for placement that comes about from the limited number of treatment centers in the awareness of the referring institution's employee due to the referring institution's employee no longer being responsible for finding and managing manual lists of treatment centers.

Another advantage of the claimed invention is a decrease in the likelihood of hospital reentry due to improved quality of matching and quicker placement of patients in treatment facilities.

Another advantage of the invention is that it helps to ensure accuracy of patient information transferred between the referring institution's employee and the treatment center admissions administrators due to the ability to share electronic patient information stored by the system.

Another advantage of the claimed invention an increase in the likelihood of a match due to an increase in the number of treatment facilities included in the search.

Another advantage of the claimed invention is decreases costs due to more accurate matching, reduced hospital readmissions, quicker matching, and improved accuracy of the transfer of patient information.

Another advantage of the claimed invention is the ability to capture patient information. This provides the ability for high level placement evaluation to gain institutional knowledge regarding important industry statistics (e.g., rate of reentry for a given treatment center, duration of hospital stay in view of duration of treatment center stay, case mix of clinical attributes and needs of patients, patient special equipment requested, frequent infections of incoming patients, average length of stay by specific patient attributes, largest referral sources (by hospital, physician), breakdown of payer mix by patient type, high cost meds requested.

In one aspect, the invention involves a computerized-method for matching a patient with a treatment center. The method involves receiving, by a first computing device, a request for a determination of availability of at least two treatment centers of a plurality of treatment centers, the request comprising patient information, transmitting, from the first computing device, the request to respective computers of each of the two treatment centers of the plurality of treatment centers, establishing, by the first computing device, one messaging session with each of the respective computer devices of each of the two treatment centers of the plurality of treatment centers, attaching, by the first computing device, at least a portion of the patient information to each messaging session, displaying, by the first computing device, each messaging session and the portion of the patient information, and receiving, by the first computing device, a determination of availability from each of the respective computer devices of each of the two treatment centers of the plurality of treatment centers.

In some embodiments, the treatment center is a skilled nursing facility, home health agency, a home health facility, an assisted living facility, a mental health facility, a Long Term Acute Care Hospital, psychiatric hospital, specialty hospital, or any combination thereof.

In some embodiments, the patient information includes an expected duration of stay. In some embodiments, the patient information includes clinical attributes of the patient. In some embodiments, the patient information includes a gender, date of birth, payer source, or payer provider number of the patient. In some embodiments, the patient information includes insurance information of the patient.

In some embodiments, the insurance information includes type of insurance, remaining insurance benefits for the year, or any combination thereof. In some embodiments, the method further comprises transmitting, by the first computing device, the request to a third computing device, the third computing device includes a repository for matching patients with treatment centers.

In some embodiments, the first computing device is a tablet, smart phone or a computer. In some embodiments, the second computing device is a tablet, smart phone or a computer.

In another aspect, the invention involves a computerized-method of determining patient bed availability in a treatment center. The method involves receiving, by a computing device, a request to admit a patient in the treatment center, the request comprising patient information, determining, by the computing device, whether the patient is a match for the treatment center based on the patient information and information of one or more current patients in the treatment center, displaying, by the computing device, a bed placement position for the patient at the treatment center, in the event the patient can be admitted by the treatment center, and transmitting, by the computing device, an available bed or unavailable bed indicator in response to the request.

In some embodiments, the determination further comprises reconfiguring bed placement for current patients if the patient cannot be admitted to the treatment center with all current patients in their current bed placement, such that the patient can be admitted to the treatment center.

In some embodiments, the treatment center is a skilled nursing facility, a home health facility, an assisted living facility, a mental health facility, a LTAC, or any combination thereof.

In some embodiments, the patient information includes an expected duration of stay. In some embodiments, the patient information includes clinical attributes of the patient. In some embodiments, the patient information includes a gender, date of birth, payer source, or payer provider number of the patient. In some embodiments, the patient information includes insurance information of the patient. In some embodiments, the insurance information includes type of insurance, remaining insurance benefits for the year, or any combination thereof.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing a computing system for matching a patient with a treatment center, according to an illustrative embodiment of the invention.

FIG. 2 is a flow diagram showing a method for matching a patient with a treatment center, according to an illustrative embodiment of the invention.

FIG. 3 is a flow diagram showing a method for determining patient bed availability in a treatment center, according to an illustrative embodiment of the invention.

FIGS. 4A-4O are illustrative views of interfaces of a system for matching a patient with a treatment center, according to illustrative embodiments of the invention.

### DETAILED DESCRIPTION

Generally, a method for matching a patient with a treatment center is provided. For each treatment center, a plurality of treatment center characteristics are stored in a treatment center marketplace computing device. When a patient needs to be placed in a treatment center, a referring institution's employee inputs information relating to the patient into a computing device of the institution. The patient's information is transmitted to the treatment center marketplace computing device. The treatment center marketplace computing device evaluates the patient's information against characteristics of the plurality of treatment centers to determine one or more treatment centers of the plurality of treatment centers that may be a match for the patient's needs. For example, the treatment center market place computing device can match the patient with treatment center based on care needs of the patient, care capabilities of the treatment center and/or availability of beds. Other criteria for matching are discussed in further detail below. The referring institution's employee can limit the options by selecting a subset of the matches made by the treatment center marketplace to be considered.

A request for availability is sent to computing devices of each treatment center that the treatment center marketplace matches the patients with (or the subset selected by the referring institution's employee). Upon receiving the request, the computing device of each treatment center determines whether the patient is suitable to offer a bed. The determination is based on the patient information and the information of one or more patients already admitted in the treatment center and/or center resources (e.g., available equipment, staff and/or medical specialties). For example, if the patient seeking admittance is female with particular infections, a determination is made as to whether there are any beds within the treatment center than can take a female patient based on the gender, infections and/or needs of the patient in an adjacent bed. Other criteria for matching at the treatment center are discussed in further detail below. In some instances, it may be necessary for the treatment center to obtain more information regarding the patient. In these instances, messages can be securely transmitted between the treatment center computing device and the referring institution's computing device within the context of the patient details. The message can be auto-generated, input by users (e.g., a treatment center admissions direction and/or a hospital administrator), or any combination thereof.

Each treatment center computing device transmits notifications once users make a decision on an available bed or unavailable bed indicator to the referring institution's computing device. Each treatment center that transmits an available bed to the referring institution's computing device can be presented to the patient, so that the patient can select the treatment center to transfer too for further care.

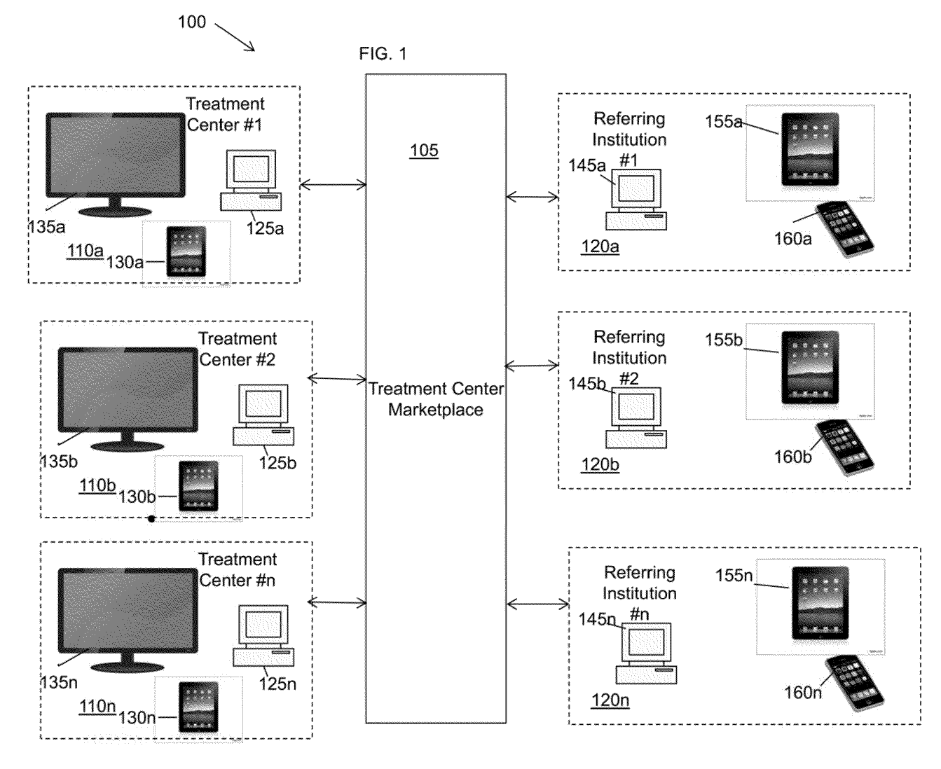

FIG. 1 is a block diagram 100 showing a computing system for matching a patient with a treatment center, according to an illustrative embodiment of the invention. The computing system includes a treatment center marketplace computing device 105, a plurality of treatment center computing systems 110a, 110b, . . . , 110n, generally 110, a plurality of referring institution computing systems, 120a, 120b, . . . 120n, generally 120.

The treatment center marketplace 105 can be a server device (including a coordinated group of connected servers), a desktop computing device, or any computing device capable of receiving, processing and transmitting marketplace data.

The treatment center computing systems 110 are in communication with the treatment center marketplace 105. The treatment center computing systems 110 can be desktop computers, tablet devices, and/or smart phones.

The treatment center marketplace 105 is in communication with the referring institution computing systems 120. The referring institution computing systems 120 can be desktop computers, tablet devise, and/or smart phones.

The plurality of treatment center computing systems 110 can each include a desktop computer 125a, 125b, . . . 125n, generally 125, a tablet 130a, 130b, . . . 130n, generally 130, and/or an electronic display 135a, 135b, . . . 135n, generally 135. It is apparent to one of ordinary skill that each treatment center computing system 110 can have any combination of computing devices, computing device types that are not shown and that the configuration shown in FIG. 1 is for exemplary purposes only.

In some embodiments, the electronic display 135 outputs a bed board that indicates patient information regarding currently admitted treatment center patients. In some embodiments, when the treatment center computing system 110 transmits an admit message to the hospital, the bed board is updated with the patient's information.

The plurality of referring institution computing systems 120 can each include a desktop computers 145a, 145b, . . . 145n, generally 145, a tablet 155a. 155b, . . . 155n, generally 155, and/or a smart phone 160a, 160b, . . . 160n, generally 160. It is apparent to one of ordinary skill that each referring institution computing system 120 can have any combination of computing devices, computing device types that are not shown and that the configuration shown in FIG. 1 is for exemplary purposes only.

During operation, one or more of the plurality of referring institution computing systems 120 transmits a request for a determination of availability to the treatment center marketplace 105. For each request for a determination of availability received by the treatment center marketplace 105, the treatment center marketplace 105 matches the request with every treatment center stored in its database that provides the type of service needed by the patient based on patient information transmitted with the request. The treatment center marketplace 105 transmits the request to each treatment center computing system 110 that the patient information matched with.

Upon receipt of a request, each treatment center computing system 110 determines availability based on the patient information received with the request.

A messaging session can be initiated between one of the computing devices of the respective treatment center computing system 110 and one of the computing devices of the respective referring institution computing system 120 via the treatment center marketplace 105. In various embodiments, the messaging session is voice, text and/or multimedia. In these embodiments, treatment center admissions personnel and referring institution personnel can communicate in real-time about the patient and the treatment center can obtain additional information regarding the patient that is needed to make a determination of availability.

In some embodiments, the treatment center computing system 110 determines that additional information is required before a determination can be made. In some embodiments, requests for additional information are transmitted from the respective treatment center computing system 110 directly to the referring institution computing system 120 that transmitted the admittance determination request via the internet.

In some embodiments, one or more of the treatment center computing systems 110 can auto generate a request for additional information.

Once a determination of availability is made by the respective treatment center computing device 110 (and/or the treatment center admissions personnel), the determination is transmitted to the respective referring institution computing system 120 via a direct connection or transmitted through the treatment center marketplace 105.

In some embodiments, once the patient has been placed in a treatment center, the treatment center provides additional information to the treatment center marketplace 105. For example, the treatment center can transmit length of stay, cost of stay, type of illness, stage of illness, reason for hospitalization, special equipment needed, hospital readmission triggers, infections, functional and mental status, home arrangements, and/or rehabilitation needed, amount covered by insurance, or any other specific field of data relating to beds and patients for the purpose of general business intelligence, identifying trends and providing analytics to each participating entiy, or any combination thereof. It is apparent to one of ordinary skill that any information input to the treatment center computing devices 110 via a structured data field can be captured by the treatment center marketplace.

Each of the treatment center computing systems 110 transmits characteristics of the treatment center and characteristics of the treatment centers computing systems devices to the treatment center marketplace 105. The treatment center marketplace 105 stores the characteristics of each treatment center and characteristics of the treatment centers computing systems devices in the treatment center marketplace 105.

The treatment center characteristics can include treatment center type, treatment center address, insurances accepted by the treatment center, medical specialties of the treatment center, names of doctors affiliated with the treatment center, details of services and capabilities of the treatment center, or any combination thereof. The treatment center characteristics can be transmitted to the treatment center marketplace at any time during operation of the system. For example, treatment center computing system 110b can be instructed to transmit its respective treatment center characteristics in real-time, every time a new patient is admitted to the treatment center. In another example, the treatment center computing system 110a can be instructed to transmit its respective treatment center characteristics at a time interval (e.g., every Monday).

The characteristics of each treatment center computing systems devices can be used by the treatment center marketplace 105 to determine what type of real-time messaging can be set up between the treatment center computing system 110 and a referring institution computing system 120.

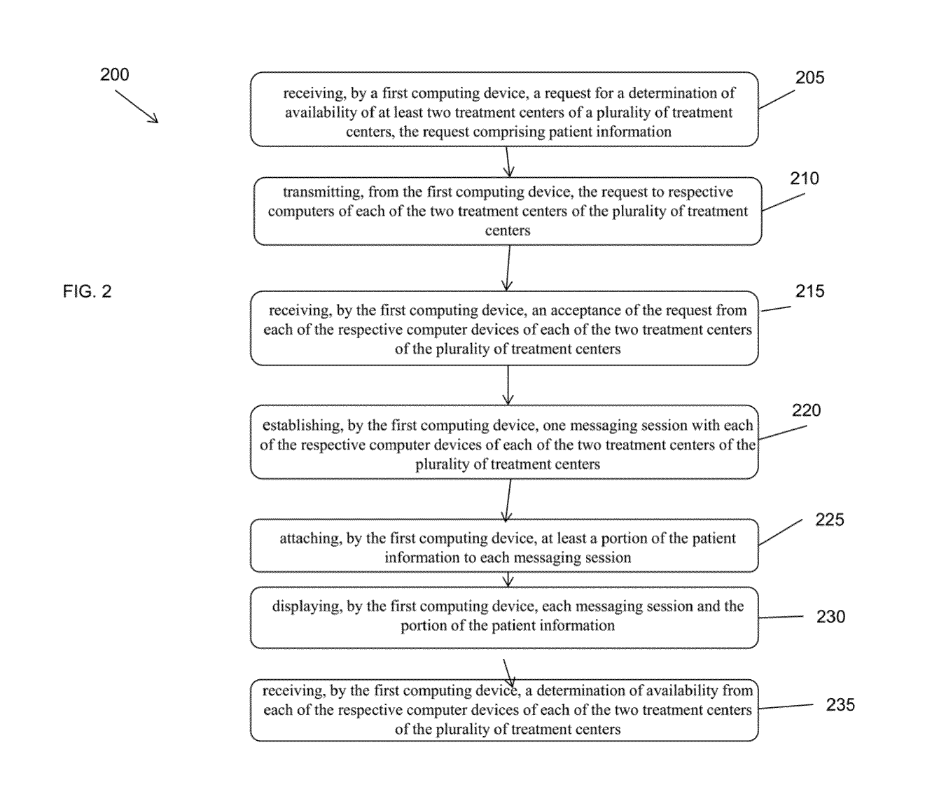

FIG. 2 is a flow diagram 200 showing a method for matching a patient with a treatment center, according to an illustrative embodiment of the invention.

The method involves receiving, by a first computing device (e.g., the treatment center marketplace 105, as described above in FIG. 1), a request for a determination of availability of at least two treatment centers of a plurality of treatment centers, the request including patient information (Step 205). The request can be transmitted by a referring institution computing device. The referring institution computing device can be a hospital, physician offices, urgent care clinics, home health agencies, Long Term Acute Care Hospitals, or any combination thereof.

The patient information can include demographic information about the patient (e.g., name, gender, date of birth, address, primary physician name, referring entity, or any combination thereof. The patient information can include clinical attributes of the patient (e.g., type of illness, stage of illness, reason for hospitalization, special equipment needed, hospital readmission triggers, infections, functional and mental status, home arrangements, and/or rehabilitation needed). The patent information can include expected duration of stay.

The method also involves, transmitting, from the first computing device, the request to respective computers of each of the two treatment centers (e.g., tablet 130a of treatment center computing system 110a, and desktop computer 125b of treatment center computing system 110b, as shown above in FIG. 1) of the plurality of treatment centers (Step 210).

In various embodiments, the treatment center is a skilled nursing facility, home health agency, a home health facility, an assisted living facility, a mental health facility, a Long Term Acute Care Hospital, psychiatric hospital, specialty hospital, or any combination thereof.

The method also involves, establishing, by the first computing device, one messaging session with each of the respective computer devices of each of the two treatment centers of the plurality of treatment centers (Step 215). In various embodiments, each messaging session is between a desktop computer, a table, a smartphone, or any combination thereof.

The method also involves attaching, by the first computing device, at least a portion of the patient information to each messaging session (Step 220). The messaging session can include comments users add regarding the patient or the treatment centers needs and/or attributes. The messaging session can allow for a central place to display, share and/or store discussions about a patient. This is advantageous in that patient's and referring institution caregivers do not need to monitor and/or review emails, attachments, faxes or voicemails to complete the profile of a patient for the purpose of making a decision of whether the treatment center will make an offer of a bed to the patient.

The method also involves displaying, by the first computing device, each messaging session and the portion of the patient information (Step 225).

The method also involves receiving, by the first computing device, a determination of availability from each of the respective computer devices of each of the two treatment centers of the plurality of treatment centers (Step 230).

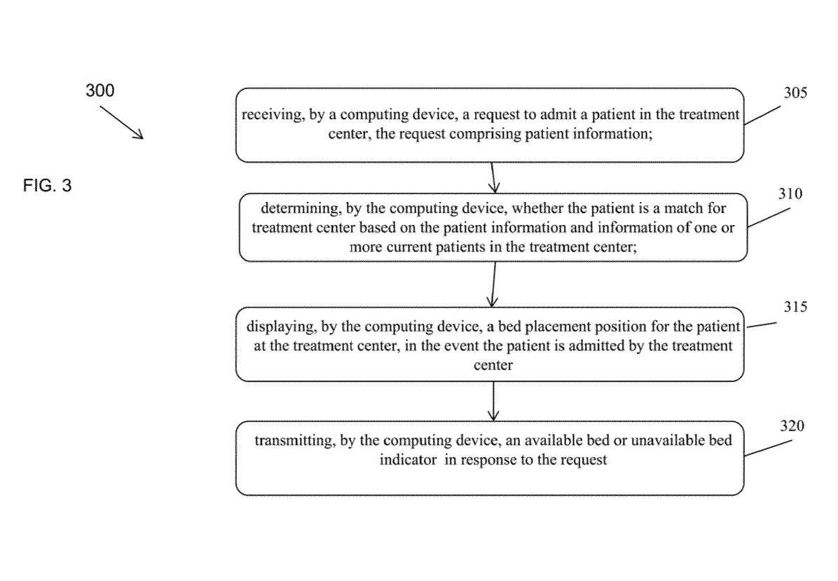

FIG. 3 is a flow diagram 300 showing a method for determining patient bed availability in a treatment center, according to an illustrative embodiment of the invention. The method involves receiving, by a computing device, a request to admit a patient in the treatment center, the request comprising patient information (Step 305). The patient information can include demographic information about the patient (e.g., name, gender, date of birth, address, primary physician name, referring entity, or any combination thereof. The patient information can include clinical attributes of the patient (e.g., type of illness, stage of illness, reason for hospitalization, special equipment needed, hospital readmission triggers, infections, functional and mental status, home arrangements, and/or rehabilitation needed). The patent information can include expected duration of stay.

The method also involves, determining, by the computing device, whether the patient is a match for the treatment center based on the patient information and information of one or more current patients in the treatment center (Step 310).

In some embodiments, determining whether a patient is match involves determining a first group of treatment centers that are a possible match based on geographic proximity between the patient's residence and the treatment center, geographic proximity between the referring institution and the patient's residence, treatment center capabilities for the patient's needs and/or availability of beds. Then, once the first group of treatment centers is determined, a second group of treatment center that are a match is determined. The second group of treatment centers that can be a match is limited to treatment centers within the first group of treatment centers. From the first group of treatment centers, the second group of treatment centers is based on patient gender versus gender required by the treatment center for the available bed, a comparison of infection compatibility between the patient and the occupant of the adjacent open bed, or any combination thereof.

The compatibility of infections can be based on infection type and/or stage of the infection. For example, a patient with HIV should not be housed in the same room with a patient with an active tuberculosis infection.

In some embodiments, a rule engine is employed to determine compatibility of infections.

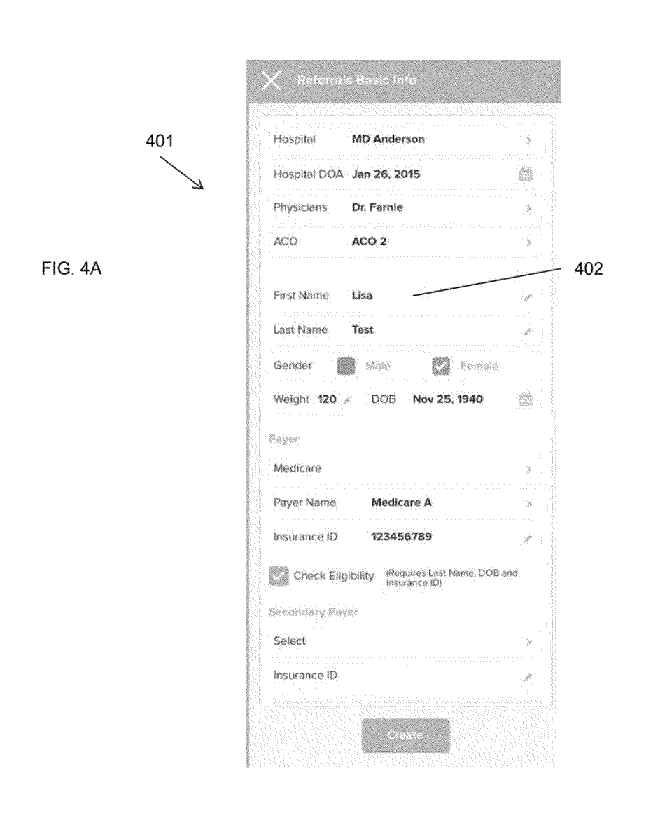

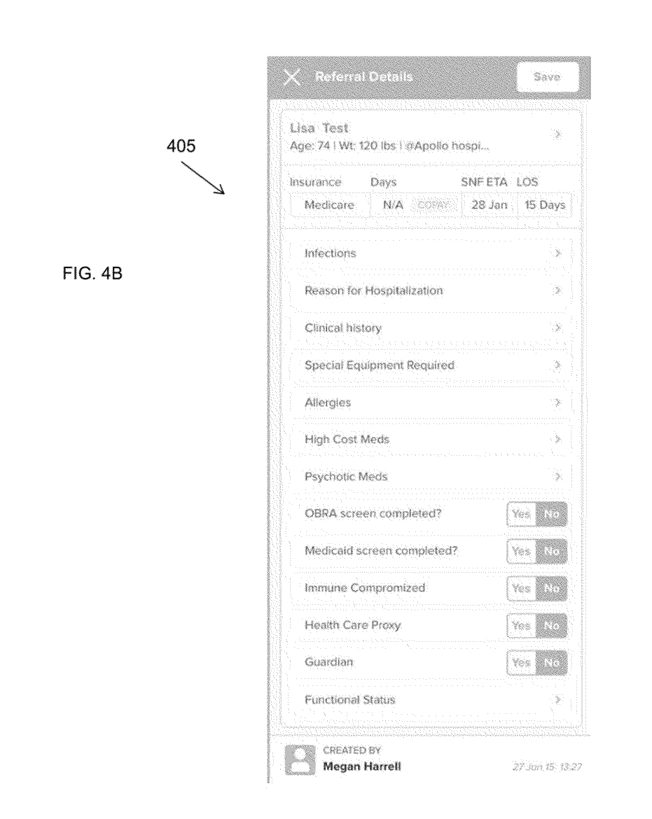

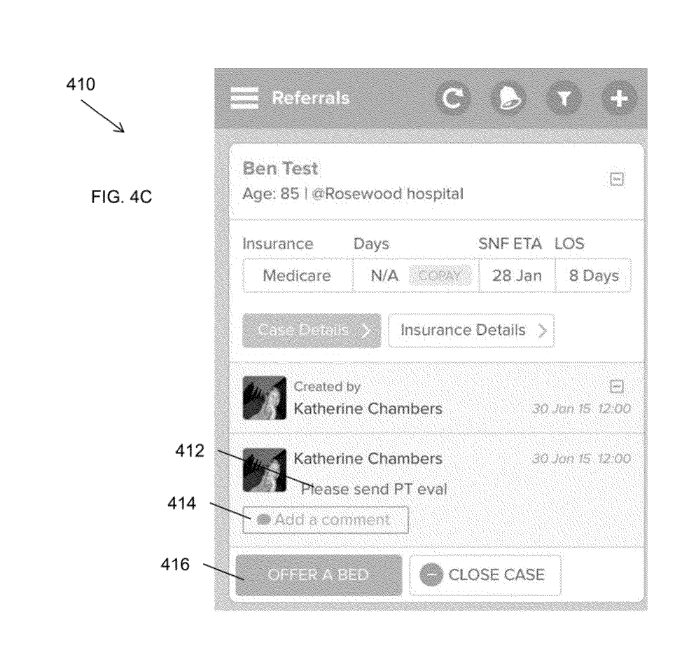

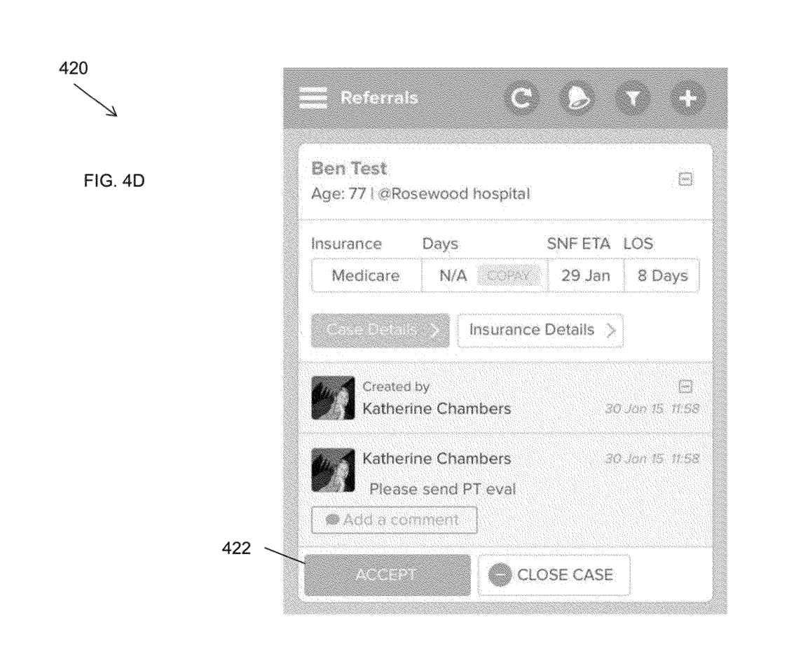

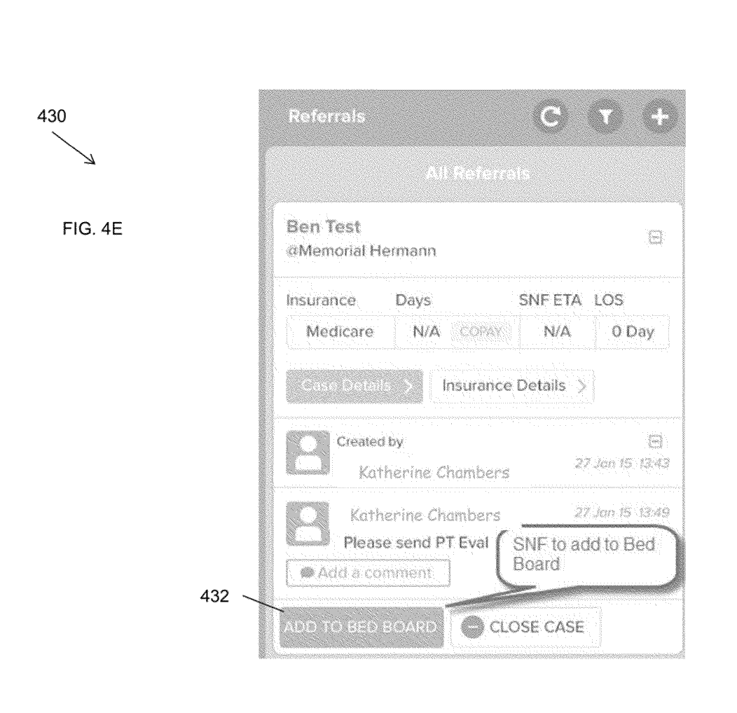

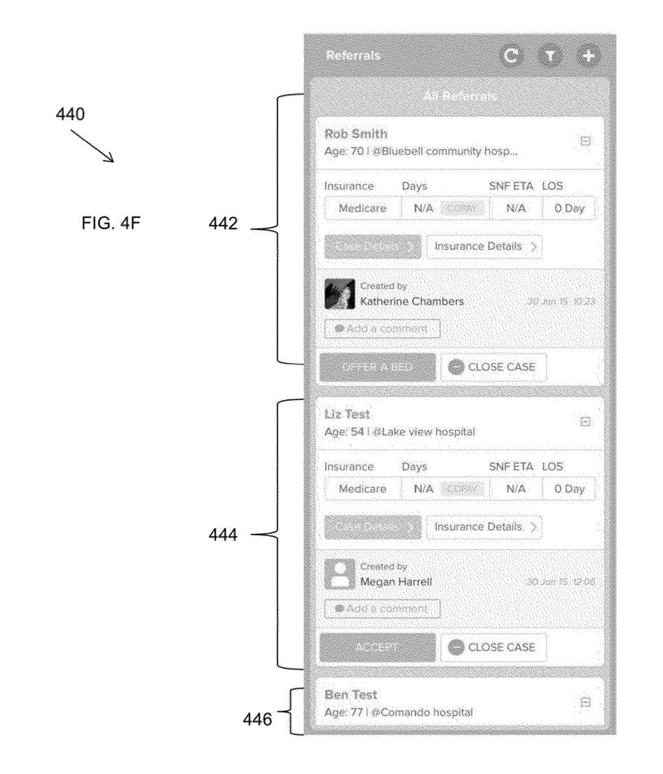

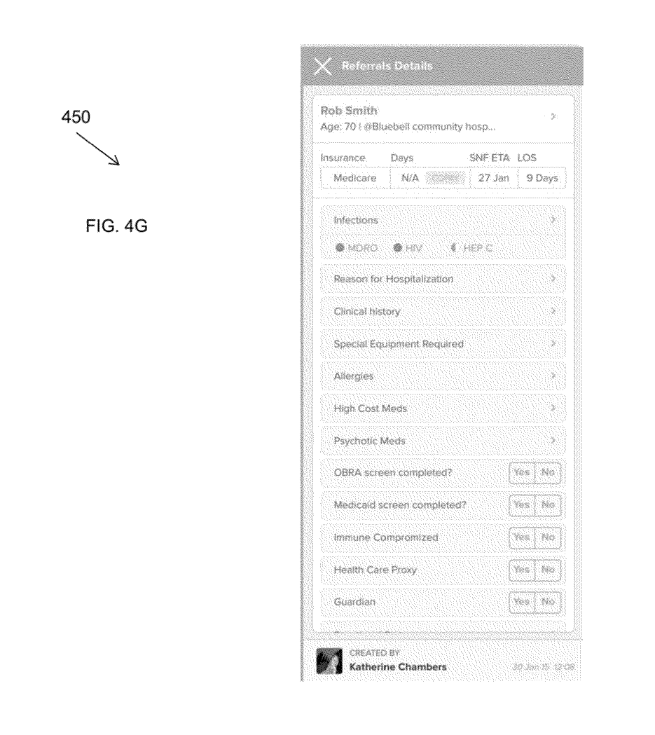

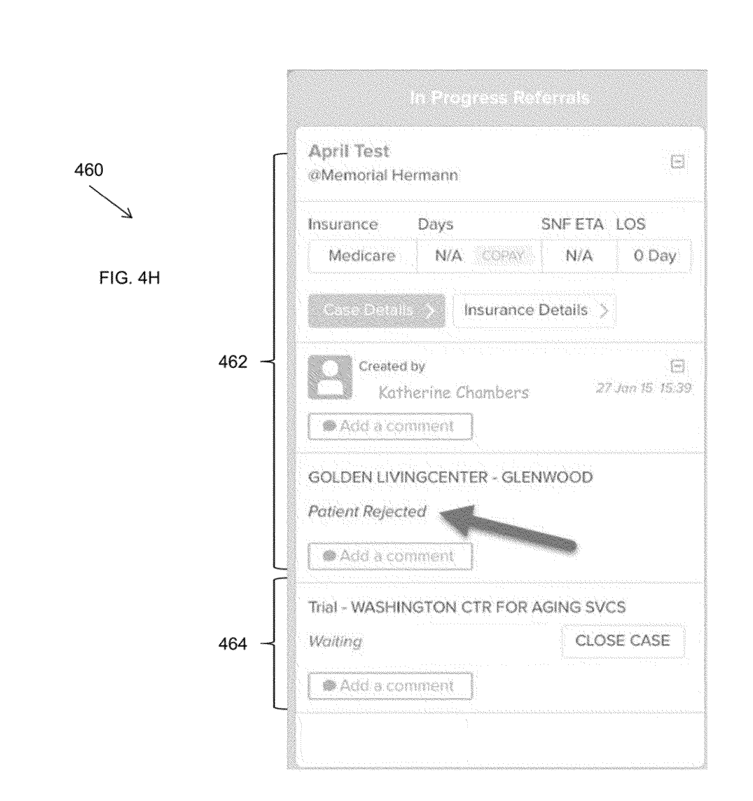

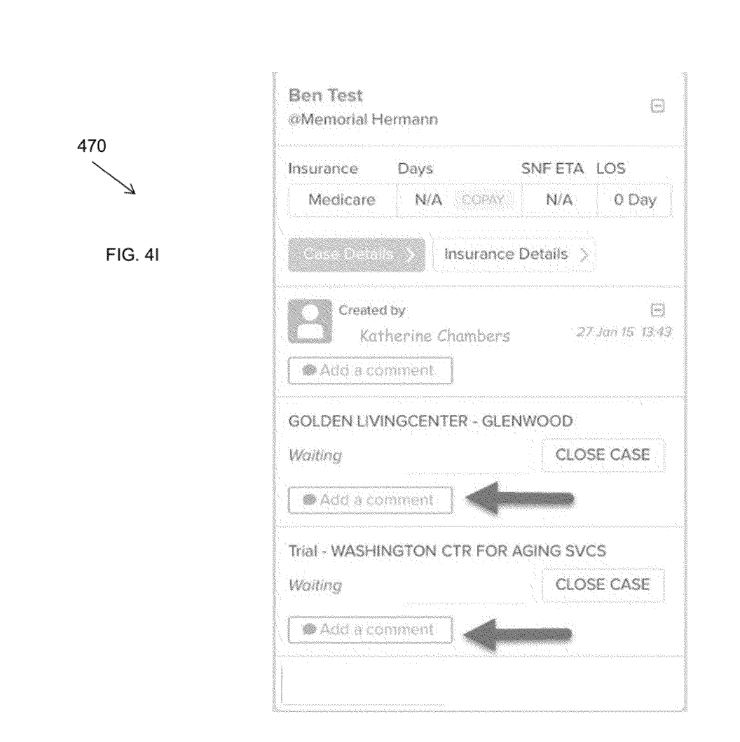

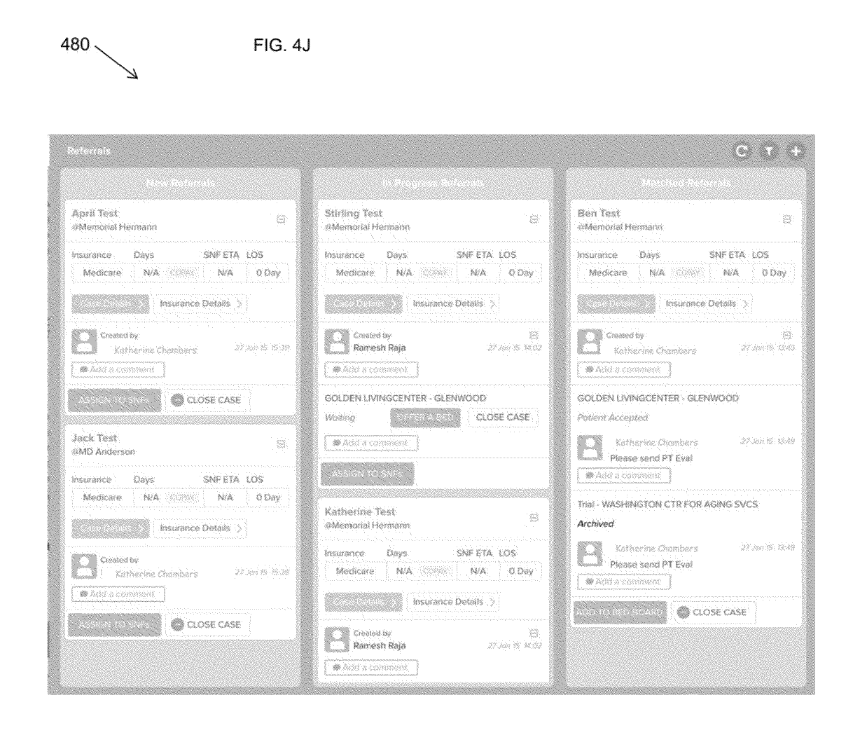

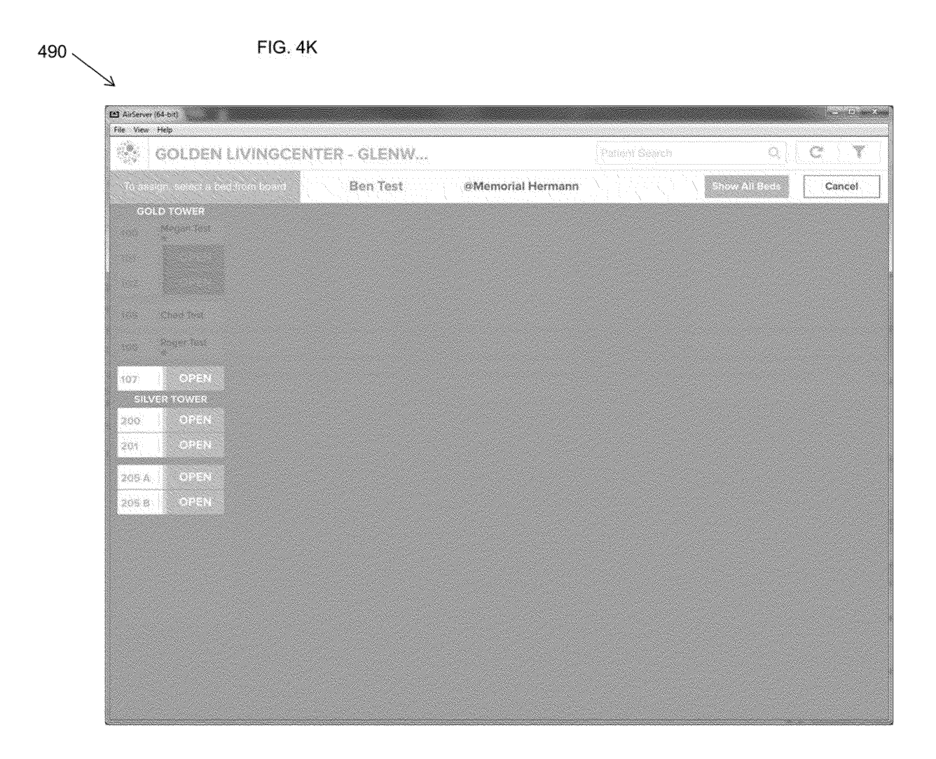

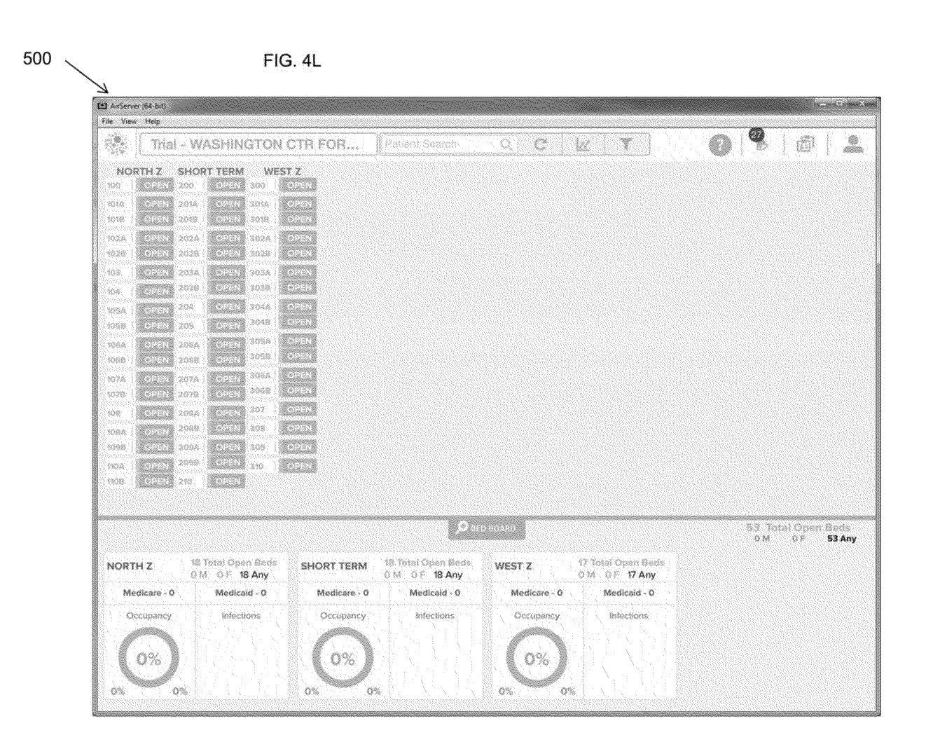

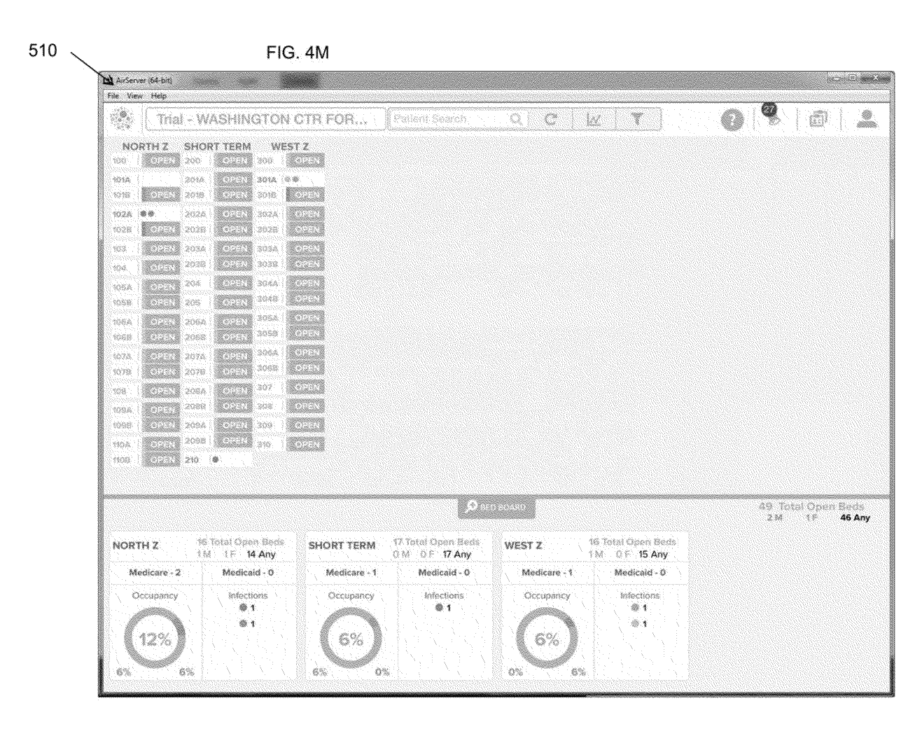

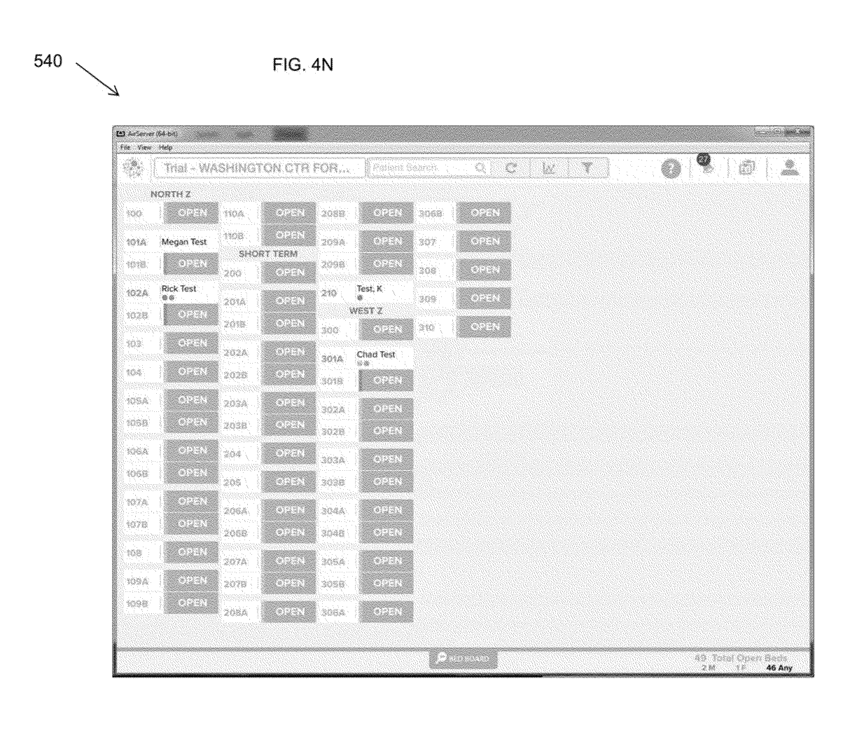

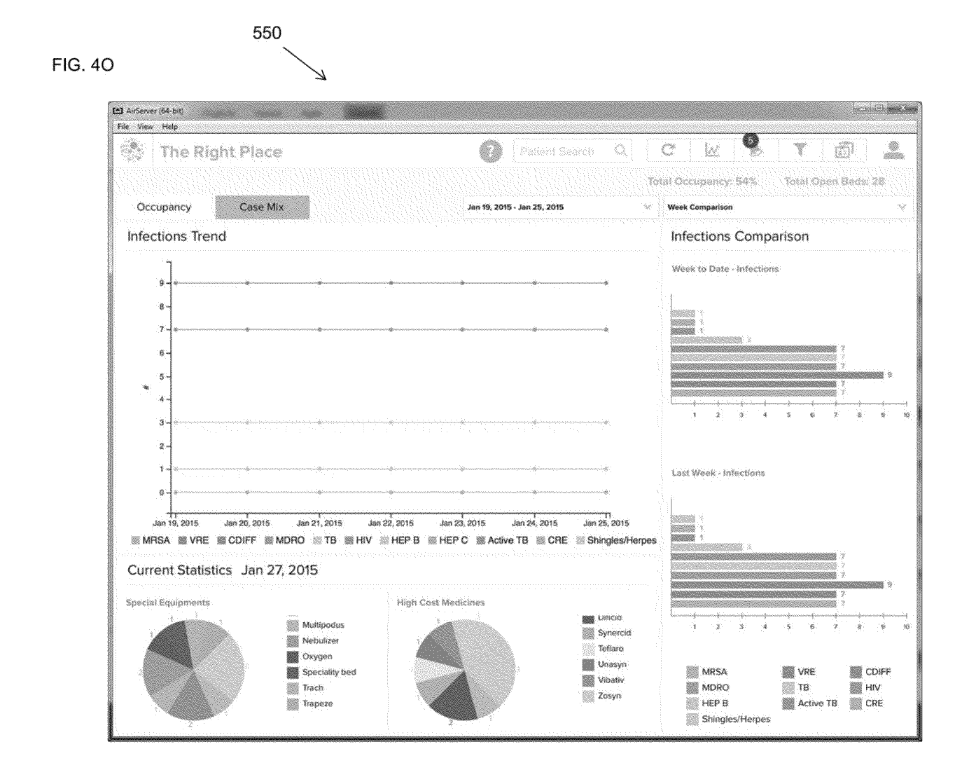

The method also involves, displaying, by the computing device, a bed placement position for the patient at the treatment center, in the event the patient can be admitted by the treatment center (Step 315). The bed placement position can displayed as shown in further detail in FIGS. 4K-4P, and as discussed below.

The method also involves, transmitting, by the computing device, an available bed or unavailable bed indicator in response to the request (Step 320), for example, once the treatment facility has made a determination of offering a bed to the patient or declining.

FIGS. 4A-4O are illustrative views of interfaces of a system for matching a patient with a treatment center, according to an illustrative embodiment of the invention.

FIG. 4A shows an exemplary interface 401 to create a new referral, according to an illustrative embodiment of the invention. The interface 401 includes multiple user input boxes for inputting the patient's information. For example, the interface 401 includes a user input box 402 for inputting the patient's name. In this example, the patient's first name is Lisa. The referral can be created by a referring institution employee. In some embodiments, if a treatment center is provided the referral information outside of the system, the treatment center employee can create the referral at the treatment center.

FIG. 4B shows an exemplary interface 405 to create a new referral, according to an illustrative embodiment of the invention. The interface 405 includes user data entry options to input medical information about the patient. For example, the user can input information regarding infections of the patient.

FIG. 4C shows an exemplary interface 410 for viewing a referral, according to an illustrative embodiment of the invention. The interface 410 is created after a request for patient placement is made. The interface 410 can provide salient patient information in a user friendly format. The interface 410 displays to a treatment center employee the location of the patient (e.g., Memorial Hermann), the patient's insurance, the person who created the referral, and additional information as shown. The treatment center employee can view a message 412 from an employee of the institution that created the referral. The treatment center employee can add a comment to send a message 414 to the referrer. The treatment center employee can depress the offer a bed button 416 if a decision is made to offer a bed to the patient.

FIG. 4D shows an exemplary interface 420 for viewing a referral, according to an illustrative embodiment of the invention. The interface 410 is created after an offer to place the patient is made (e.g., to the referral institution employee). The interface 410 displays substantially the same information as is shown in interface 410 that allows an offer of a bed to be made. The bed offer can be accepted by depressing the “accept” button 422.

FIG. 4E shows an exemplary interface 430 for viewing a referral, according to an illustrative embodiment of the invention. The interface 430 allows the treatment center to add a patient to its bed board in the event that the patient accepts the treatment center's offer for a bed by depressing the “add to bed board button” 432.

FIG. 4F shows an exemplary interface 440 for viewing multiple referrals, according to an illustrative embodiment of the invention. The first referral 442 and the second referral 444 are shown in an expanded view. The third referral 446 is shown in a collapsed view. In some embodiments, an “offer bed” button (not shown) is presented within the referral information for each referral, such that a bed offer can be made for each referral.

FIG. 4G shows an exemplary interface 450 for viewing referral information, according to an illustrative embodiment of the invention. The interface 450 shows detailed patient information for a referral.

FIG. 4H shows an exemplary interface 460 for viewing referral information, according to an illustrative embodiment of the invention. The interface 460 shows a rejected referral 462 and a pending referral 464.

FIG. 4I shows an exemplary interface 470 for viewing referral information, according to an illustrative embodiment of the invention.

FIG. 4J shows an exemplary interface 480 for viewing referral information, according to an illustrative embodiment of the invention. Interface 480 shows the referral information from the perspective of a treatment center. In some embodiments, the same information is presented to a referring institution, however, the “offer a bed” buttons and the “add to bed board buttons” are not present.

FIG. 4K shows an exemplary interface 490 for a bed board, according to an illustrative embodiment of the invention. The interface 490 shows available beds for the patient “Ben Test”.

FIG. 4L shows an exemplary interface 500 for a bed board, according to an illustrative embodiment of the invention. The interface 500 shows three bed zones for a treatment facility. The facility shown has 100% availability.

FIG. 4M shows an exemplary interface 510 for a bed board, according to an illustrative embodiment of the invention. The interface 510 shows beds that are occupied via the white slots. Blue text next to the white slot indicates male occupants and pink text next to the white slots indicates female occupants. Dots within the white slots show infection type.

FIG. 4N shows an exemplary interface 520 for a bed board, according to an illustrative embodiment of the invention. Interface 520 is an expanded view the bed board that allows for viewing of the patient's names.

FIG. 4O shows an exemplary interface 540 for presenting analytic data captured by a treatment center market place, according to an illustrative embodiment of the invention. The interface 540 shows specific analytics from a treatment center perspective for their treatment center.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example, semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, or tablet) with a World Wide Web browser (e.g., Microsoft® Internet Explorer® available from Microsoft Corporation, Chrome available from Google. Mozilla® Firefox available from Mozilla Corporation. Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (IHAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized-method for matching a patient with a treatment center, the method comprising:
receiving, by a first computing device, a request for a determination of availability of at least two treatment centers of a plurality of treatment centers, the request comprising patient information;
transmitting, from the first computing device, the request to respective computers of each of the two treatment centers of the plurality of treatment centers;
establishing, by the first computing device, one messaging session with each of the respective computer devices of each of the two treatment centers of the plurality of treatment centers;
attaching, by the first computing device, at least a portion of the patient information to each messaging session;
displaying, by the first computing device, each messaging session and the portion of the patient information; and
receiving, by the first computing device, a determination of availability from each of the respective computer devices of each of the two treatment centers of the plurality of treatment centers.

2. The computerized-method of claim 1 wherein the treatment center is a skilled nursing facility, home health agency, a home health facility, an assisted living facility, a mental health facility, a Long Term Acute Care Hospital, psychiatric hospital, specialty hospital, or any combination thereof.

3. The computerized-method of claim 1 wherein the patient information includes an expected duration of stay.

4. The computerized-method of claim 1 wherein the patient information includes clinical attributes of the patient.

5. The computerized-method of claim 1 wherein the patient information includes a gender, date of birth, or any combination thereof.

6. The computerized-method of claim 1 wherein the patient information includes insurance information of the patient.

7. The computerized-method of claim 6 wherein the insurance information includes type of insurance, remaining insurance benefits for the year, or any combination thereof.

8. The computerized-method of claim 1 further comprises transmitting, by the first computing device, the request to a third computing device, the third computing device includes a repository for matching patients with treatment centers.

9. The computerized-method of claim 1 wherein the first computing device is a tablet, smart phone or a computer.

10. The computerized-method of claim 1 wherein the second computing device is a tablet, smart phone or a computer.

11. A computerized-method of determining patient bed availability in a treatment center, the method comprising:
receiving, by a computing device, a request to admit a patient in the treatment center, the request comprising patient information;
determining, by the computing device, whether the patient is a match for the treatment center based on the patient information and information of one or more current patients in the treatment center;
displaying, by the computing device, a bed placement position for the patient at the treatment center, in the event the patient is admitted by the treatment center; and
transmitting, by the computing device, an available bed or unavailable bed indicator in response to the request.

12. The computerized-method of claim 13 wherein the determination further comprises reconfiguring bed placement for current patients if the patient cannot be admitted to the treatment center with all current patients in their current bed placement, such that the patient can be admitted to the treatment center.

13. The computerized-method of claim 13 wherein the treatment center is a skilled nursing facility, a home health facility, an assisted living facility, a mental health facility, a LTAC, or any combination thereof.

14. The computerized-method of claim 13 wherein the patient information includes an expected duration of stay.

15. The computerized-method of claim 13 wherein the patient information includes clinical attributes of the patient.

16. The computerized-method of claim 13 wherein the patient information includes a gender, date of birth, or any combination thereof.

17. The computerized-method of claim 13 wherein the patient information includes insurance information of the patient.

18. The computerized-method of claim 19 wherein the insurance information includes type of insurance, remaining insurance benefits for the year, or any combination thereof.
